(19) United States
(12) Patent Application Publication
(10) Pub. No.: US 2021/0171378 A1
(43) Pub. Date: Jun. 10, 2021

(54) METHOD AND APPARATUS FOR HIGH WATER EFFICIENCY MEMBRANE FILTRATION TREATING HARD WATER

(71) Applicants: Kevin Elliott, Burlington (CA); David Francis Rath, Grimsby (CA)

(72) Inventors: Kevin Elliott, Burlington (CA); David Francis Rath, Grimsby (CA)

(21) Appl. No.: 17/108,332

(22) Filed: Dec. 1, 2020

(30) Foreign Application Priority Data
Dec. 4, 2019 (CA) 3063650

(51) Int. Cl. C02F 5/08; B01D 61/02; B01D 61/12; C02F 1/44; C02F 1/00; B01D 65/08

(52) U.S. Cl. CPC C02F 5/08; B01D 2321/16; B01D 61/027; B01D 61/022; B01D 61/12; C02F 1/442; C02F 1/441; C02F 1/008; B01D 65/08; C02F 2201/005; C02F 2209/05; C02F 2301/046; B01D 2311/263; B01D 2311/25; B01D 2313/18; B01D 61/025

(57) ABSTRACT

A method for the treatment of water using reverse osmosis (RO) membranes and nano-filtration membranes wherein the permeate of the membranes is fluid connected to a feed water source via a pressurized storage buffer tank as well as to the fluid connection to use, the method comprising the steps of supplying treated water through a sanitary fully pressurized buffer tank, and supplying waste water through a recirc loop which contains recirculated concentrate and storing treated water in the buffer tank with low total dissolved solids of less than 10% of feed water, low pH of less than pH 7, and of low total organic carbon of less than 25% of feed water ensuring sanitary storage. It further includes opening a waste valve in the recirc loop which purges recirculated concentrate in order to rapidly reduce the conductivity of the water in the recirc loop. It further includes the steps of operating the waste valve such that it maintains the conductivity of the recirculated waste water in the recirc loop within a pre selected range of values and opening the waste valve when a measured conductivity setpoint is exceeded, and closing the waste valve when a measured conductivity setpoint is met.

The present application claims priority from Canadian application 3,063,650 filed Dec. 4, 2019 under the title METHOD AND APPARATUS FOR HIGH WATER EFFICIENCY MEMBRANE FILTRATION TREATING HARD WATER with named inventors Kevin Elliott and David Francis Rath.

### FIELD OF THE INVENTION

The present invention is related to the method of producing purified low TDS (total dissolved solids), low TOC (total organic carbon), and/or low hardness water using reverse osmosis (RO) or nanofiltration (NF) membranes. The method disclosed herein overcomes many of the drawbacks of traditional methods of applying membranes for sanitary water including reducing wastewater utilizing a relatively simple flow path. An exemplary apparatus is also described.

### BACKGROUND OF THE INVENTION

Hard water to be processed by membrane filtration typically requires pre-treatment by an ion exchange (IX) softening process in order to avoid mineral fouling of membranes at higher recovery rates. Even with pre-treatment, most small commercial (<10 GPM) RO systems produce 50% wastewater; up to 85% wastewater without pre-treatment (softening). The low water recovery (high wastewater) can incur substantial costs making the application of the technology uneconomical, especially for domestic use.

The permeate of the membrane process is typically collected in large atmospheric storage tanks in order to provide for instantaneous water demand that exceeds production rates. This is of particular concern for home and small commercial applications where the size of the tanks can be difficult to accommodate and maintaining the sanitation of the storage tanks is nearly impossible.

It is standard practice for reverse osmosis membrane systems to have the permeate and waste flow rates set to a constant rate by manual adjustment of needle valve or by fixed orifice. However, it is well understood that the permeate of these membranes decreases by approximately 3% per degree Celsius as feed water temperature drops. In applications where there is seasonal temperature variability, this results in one of three scenarios:
a) systems tuned for warm weather drop off in permeate flow during the colder months, which correspondingly increases the waste flow due to increased backpressure,
b) systems tuned for cold weather increase in permeate flow, decreasing flow to waste which can cause scaling conditions, or
c) systems tuned for the shoulder seasons have modestly increased risk of scaling in warmer weather and modestly higher waste in colder weather.

As can be seen, none of these situations come close to ideal. Additionally, these systems can only be tuned for a single water quality, which results either in membrane fouling and failure or excessive waste water production. Systems without daily monitoring and maintenance are set with relatively low recovery as safety factor to ensure fouling is avoided.

In membrane systems where a bladder tank (air ballast or water-over-water) is utilized on the permeate line to provide higher instantaneous flow rates than can be provided by the membranes directly (i.e. under-counter systems), the diaphragm inside is known to provide a surface for bacterial growth as it is in a stagnant water zone.

### SUMMARY

Disclosed is an improved method for the treatment of water by membrane filtration that allows for fully pressurized and sanitary storage, automatic pressure balancing, automatic adjustment of the permeate to incoming water quality and temperature, and periodic wastewater events yielding high recovery. Further, it allows for the implementation of the technology without the need for a normalization period and subsequent site-specific manual tuning.

The critical aspects that allow these improvements over traditional methods of implementing membrane filtration are:
a) Adding a fluid connection between the permeate conduit and the supply water conduit.
b) Adding at least one pressurized storage vessel in-line with said fluid connection.
c) Utilizing a booster pump as the main driver of permeate which sets the differential pressure across the membranes.
d) Utilizing a controller to trigger concentrate flush events based on the reading of water conductivity within the recirculation loop.

By connecting the permeate hydraulically with the supply water, hydraulic balance is automatically adjusted to the supply pressure. The in-line pressurized storage vessel(s) allows for storage of membrane-treated water that can be utilized even with the membrane system not in operation, since this flow path allows the permeate of the system to reverse direction as a “closed loop” recirculation system when no water usage is present.

Importantly, the flow through this pressurized storage vessel is preferably from one end to the other, as this eliminates stagnant areas that can encourage biological growth. This pressurized storage vessel can also be sized to supplement the production of the membrane system for a set period of time when usage flow rates exceed production rates.

With the permeate hydraulically connected to the inlet, permeate flow is determined by the pressure available from the boost pump and the TDS and temperature of the concentrate, unlike traditional applications where the supply pressure is used to provide some or all of the needed pressure to drive this flow.

In this arrangement, the boost pump causes the concentrate to recirculate through the membranes several times with the flow rate of water entering the recirc loop being equal to the permeate at times when the waste valve is closed. Once the conductivity of the water in this recirc loop reaches a setpoint as determined by a controller measuring a conductivity probe, the waste valve is opened, sending concentrated salt solution to waste until a second lower setpoint value is reached, triggering the valve to close. The bulk concentration of the scale-forming minerals is reduced well into the non-scale-forming zone, thus reducing the risk of fouling while treatment continues.

Due to the fact that scaling is a thermodynamic event that takes a non-infinitesimal amount of time, as long as the cross-flow is maintained in such a way as to minimize boundary layer conditions at the surface of the membrane and appropriate antiscalants are applied at manufacturer-specified dosages, scaling will not occur even at higher than typical water recovery values. Using a conductivity setpoint to toggle an automated valve open and closed removes the issue of temperature variation causing high waste or fouling issues as described earlier, as well as the need to tune systems based on feed water quality. Additionally, this method of purging concentrate saves anti-sealant chemicals as they are not released from the system unnecessarily while still active. Furthermore, the waste setpoint can be adjusted in order to allow use of the waste water for other less critical applications where the water is suitable, yielding a net zero discharge system.

The system can be further optimized for low fouling in applications where the system is not required to run continuously by implementing a special flush condition at the end of the production cycle. This would reduce the concentration of salts in the recirc loop to a value that is shown to be stable, such as similar to the incoming feed water. In difficult treatment applications, an intermediary tank can be added at the inlet of the treatment loop to allow for the recirc loop to be flushed with Permeate water to a concentration lower than the incoming feed water. “Treatment loop” describes the connection of the water from the feed of the recirc loop to the permeate conduit and back through the pressurized storage vessels. Allowing the membranes to sit in low TDS high quality water can help to desorb particles that have begun to foul the membranes surface, thus extending the useful life of the membranes.

### BRIEF DESCRIPTION OF THE DRAWINGS

FIG. 1 is a schematic diagram which shows the traditional flowpath of a membrane treatment system.

FIG. 2 to which the claims are directed is a schematic diagram which shows an exemplary example of the proposed flow path with fully pressurized storage tank and flow path.

FIG. 3 is a schematic diagram which shows an exemplary example of the proposed flow path supplying water to an atmospheric storage tank.

FIG. 4 is a schematic diagram which shows an alternate example of the proposed flow path supplying water to an atmospheric storage tank.

### DETAILED DESCRIPTION

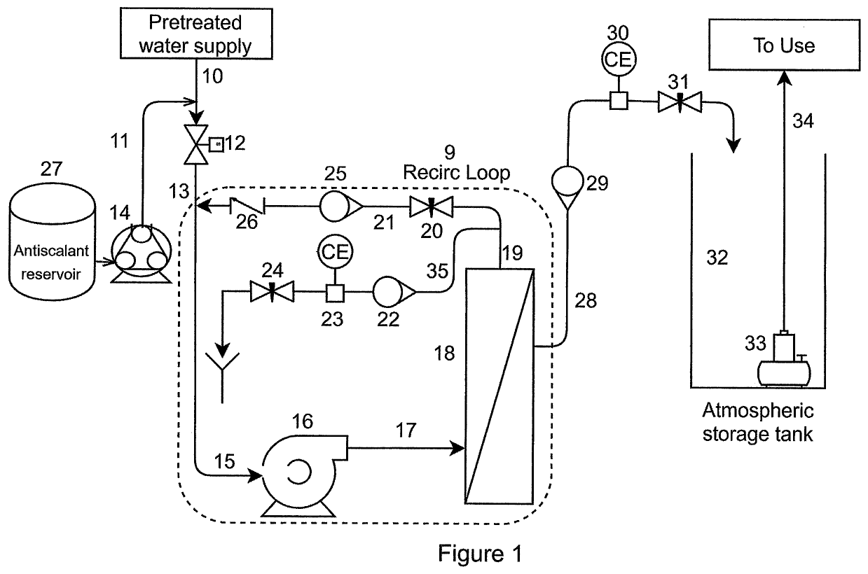

Referring to FIG. 1 which represents the current standard practice for implementing a reverse osmosis membrane system. Pretreatment may include particulate filtration to 20 microns or smaller, softening, and chlorine removal. Pretreated water 10 is fed to the recirc loop 9 through a solenoid valve 12 which opens based on a low level signal provided by a level sensor (not shown) in the atmospheric storage tank 32. Water passes into the boost pump 16 via conduit 15 where the pressure is increased at pump outlet 17 and fed to the membrane(s) 18. Permeate water is delivered to atmospheric storage tank 32 via conduit 28. Water for use is delivered from storage tank 32 by a repressurization pump 33 via conduit 34. The rejected water is recirculated back to feed conduit 15 via junction 13 through concentrate conduit 19 and 21 and check valve 26. In order to “tune” the system which sets system water recovery, an operator or installer is required to set the concentrate recirculation flow rate through conduit 21, named “cross-flow”, by using valve 20 while monitoring flow at flow sensor 25. Next the operator adjusts the waste flow rate through conduit 35 using valve 24 while monitoring flow sensor 22, or optionally by monitoring conductivity at concentrate conductivity probe 23. Once the system normalizes to temperature and accumulated concentrate TDS level, these flow rates will need to be readjusted. Additionally, given that this arrangement does not self-adjust for temperature or changes in TDS of the pretreated water, it is best practice to set a maximum permeate flow rate using valve 31 while monitoring flow sensor 29. Permeate conductivity is monitored at permeate conductivity probe 30 to ensure quality is being met and to troubleshoot issues. In systems where higher recovery is required, appropriate antiscalant chemicals from a reservoir 27 are dosed into the pretreated water in conduit 10 using a chemical feed pump 14 via an injection tube 11.

This invention proposes a method and apparatus to treat water containing dissolved ionic species such as calcium by membrane separation using a novel flow path and control strategy in order to produce water with reduced TDS, TOC and/or low hardness while minimizing produced wastewater. The following examples describe in detail the implementation of the invention, which may incorporate one or more preferred embodiments.

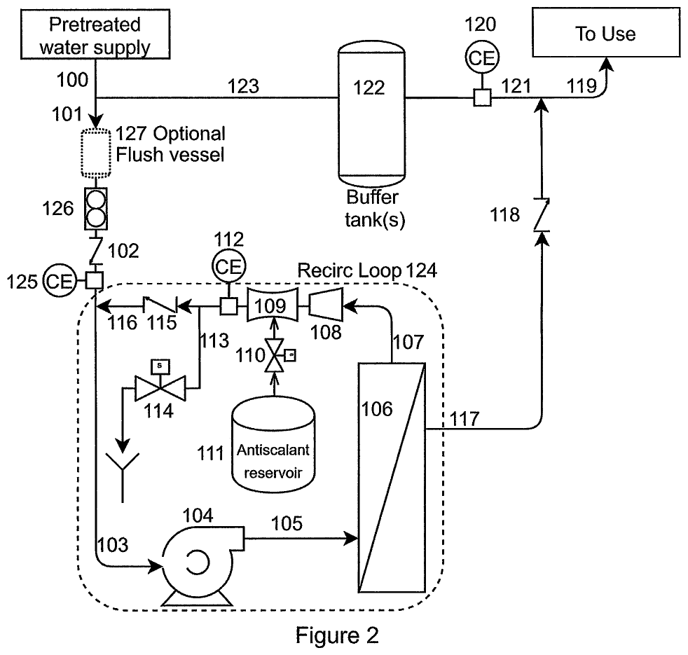

FIG. 2 displays an exemplary example of the invention that would be used for applications where demand is irregular and discontinuous, such as a residence or commercial building. Pressurized water that has been pretreated to remove particulate and typical membrane foulants (as will be known to one familiar with the art) but not hardness or alkalinity is fed to the treatment system via a feed water conduit 100 which can then be directed either into the buffer tank(s) 122 via fluid conduit 123 or into the recirc loop 124 via inlet fluid conduit 101, which is determined by hydraulics. The “recirc loop” describes the part of the system through which the concentrated salts recirculate during production, including the conduit to drain. Note recirc in this application means recirculation.

The trigger to start the treatment system is preferably reached by exceeding a setpoint of water conductivity at probe 120, which may be located along fluid conduit 121 or submersed within a buffer tank 122 or between multiple tanks. The water that enters the recirc loop via inlet fluid conduit 101 passes through check valve 102, into fluid conduit 103 and is then further pressurized by the boost pump 104 and fed via concentrate feed conduit 105 to the membrane bank 106 which may consist of one or more RO or NF membranes arranged in parallel or in series or a combination thereof as is suitable for the application and as will be known to one familiar with the art. The permeate from the membrane filtration step is collected via fluid conduit 117 and can be directed to the buffer tank(s) via fluid conduit 121 or to the premise plumbing via fluid conduit 119, or a portion can be directed to both. Check valve 118 is present to prevent reversal of flow and potential damage to membranes from reverse pressure gradient.

The proportioning of flow is determined by the hydraulics of the system at the time water is treated: if water demand to use exceeds the treatment flow rate available from the system, all of the permeate will be directed to use along with any additional volume required via 123, 122, and 121. If demand is zero, all of the permeate will be directed toward the buffer tank(s) 122 and will be recirculated back to the recirc loop 124 via fluid conduit 123 and 101. If demand is less than the production capacity of the system, the demand will be satisfied by permeate alone and any portion of the permeate not sent to use will be recirculated back through fluid conduit 121, into buffer tank 122 and into the recirc loop 124 via fluid conduit 123 and 101. At times when no flow is demanded to use 119 and permeate flow is directed solely into fluid conduit 121, a vessel 127 placed to be fed by inlet fluid conduit 101 will receive membrane-treated lowered-TDS water.

At times that this vessel 127 contains low TDS water, a waste event will draw said low TDS water into the recirc loop 124, assisting the rapid lowering of conductivity of the present solution in said loop. Vessel 127 can be sized in order to provide a complete flush of the recirc loop with permeate water prior to system shutdown.

The water rejected at the membrane(s) is collected and recirculated back to conduit 103 via concentrate conduit 107 and 116. In order to prevent a need for an operator adjusting the flow rate returned via concentrate conduit 107, a fixed orifice 108 can be implemented which is sized based on the pump sizing and membrane array and which will be known to those familiar with the art. A check valve 115 placed on concentrate return conduit 116 prevents water in feed water conduit 101 from short-circuiting to drain during waste events with the pump off.

In this process, a controller (not shown) reads a conductivity sensor 112 to measure the salinity of the Concentrate flowing through the recirc loop 124. Once this measurement reaches a prescribed setpoint, the controller opens the waste valve 114 which purges some of the recirculated water containing concentrated salts from the recirc loop 124 via waste conduit 113. A second setpoint tells the controller when to close the waste valve 114, yielding hysteresis for the control. In this way, the salts can be purged from the system only when concentrated in the recirculation water, using far less water than would traditionally be used using a fixed-flow during operation.

By integrating anti-scalant dosing directly into the recirc loop of the membrane system from an anti-scalant reservoir 111, it can be ensured that the antiscalant is applied to the concentrate and is not added to the buffer tank(s) 122, as may occur if the traditional injection point was used. The use of an automated valve 110 on the suction line of the venturi 109 allows for precise dosing control based either on volume treated by the system or by accumulated TDS added to the recirc loop, as calculated by the controller using the inlet conductivity probe 125 and inlet flow sensor 126.

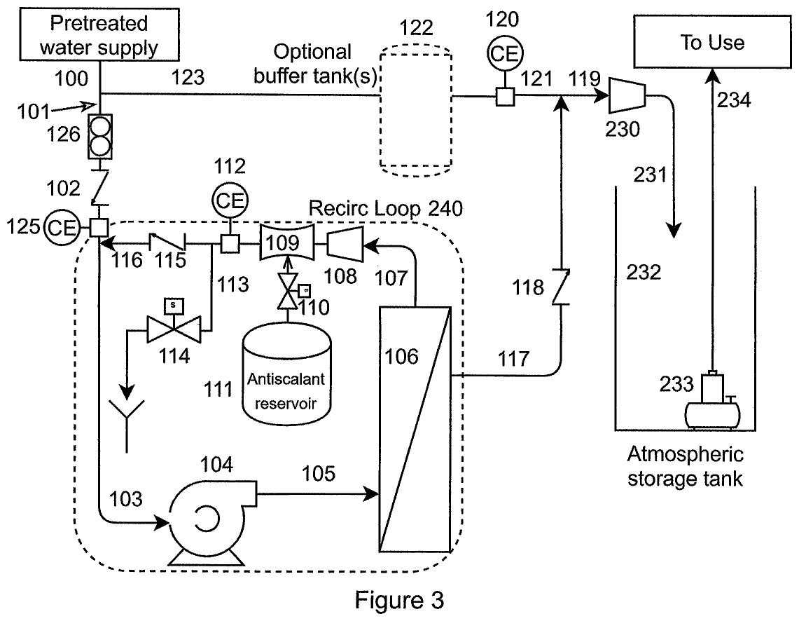

FIG. 3 displays an example of the invention implemented in order to provide membrane-treated water to an unpressurized atmospheric storage tank 232. The main difference here is that the buffer tank(s) 122 becomes optional and a method of controlling the flow rate to fill the tank 232, such as a fixed orifice or diaphragm valve 230, is necessary in order to provide back pressure to maintain the pressurized state of the treatment system. This is critical as this pressure is used to flush water from the recirc loop 124 to waste 114, and also prevents the atmospheric storage tank 232 from receiving untreated water due to demand flow rates far in excess of the treatment capacity. The control of water flow into the tank is controlled via level sensor and valve appropriate to the application, as would be known to one familiar with the art (not shown). Treated water is delivered to use via fluid conduit 234 from the atmospheric storage tank 232 by re-pressurizing using a pump 233 which is sized as appropriate to the application.

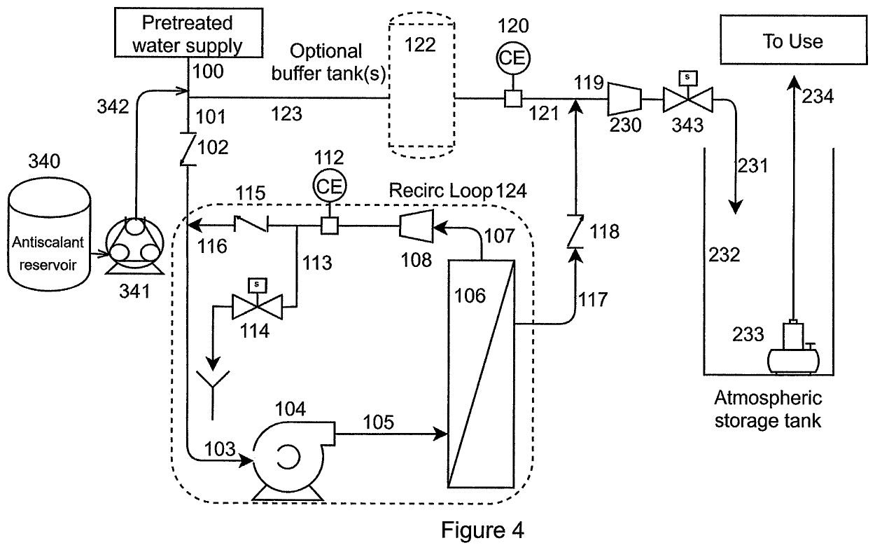

FIG. 4 displays an alternate example of the proposed flow-path supplying water to an atmospheric storage tank 232. In this example, anti-sealant from a reservoir 305 is provided by chemical feed pump 340 via injection tube 341 into pretreated water conduit 100 via injection tube 342 in the traditional way, since the flow restrictor 222 would normally be sized at or somewhat below the treatment capacity of the system. In this arrangement, during production all of the pretreated water that enters the system travels into the recirc loop 124 via fluid conduits 100, 101 and 103, thus none of the injected antiscalant is transported into the atmospheric storage tank 233. Alternately, the antiscalant could be delivered directly into conduit 101 or 103 to ensure it is delivered only to the recirc loop 124. The control of water addition to the atmospheric storage tank 232 can be performed by measurement of liquid level in atmospheric storage tank 232 by means of a float or other method known to one familiar with the art, and using this signal to open and close a solenoid valve 343 as is appropriate to maintain treated water in the atmospheric tank 232.

We claim:

1. A method for the treatment of water using reverse osmosis (RO) membranes and nano-filtration membranes wherein the permeate of the membranes is fluid connected to a feed water source via a pressurized storage buffer tank as well as to the fluid connection to use, the method comprising the steps;
a) supplying treated water through a sanitary fully pressurized buffer tank, and supplying waste water through a recirc loop which contains recirculated concentrate;
b) storing treated water in the buffer tank with low total dissolved solids of less than 10% of feed water, low pH of less than pH 7, and of low total organic carbon of less than 25% of feed water ensuring sanitary storage;
c) opening a waste valve in the recirc loop which purges recirculated concentrate in order to rapidly reduce the conductivity of the water in the recirc loop.

2. The method set out in claim 1 further including the following steps:
a) operating the waste valve such that it maintains the conductivity of the recirculated waste water in the recirc loop within a pre selected range of values;
b) opening the waste valve when a measured conductivity setpoint is exceeded; and
c) closing the waste valve when a measured conductivity setpoint is met.

3. The method set out in claim 2 further including the following step:
a) dosing an anti-scalant chemical into the recirc loop of the system by operating an automated valve fluid connected to the suction port of a venturi using a control system in order to dose the anti sealant into the flowing waste water.
